(19) United States
(12) Patent Application Publication
(10) Pub. No.: US 2025/0158678 A1
(43) Pub. Date: May 15, 2025

(54) METHOD AND APPARATUS FOR CHANNEL INFORMATION FEEDBACK IN MOBILE COMMUNICATIONS

(71) Applicant: MEDIATEK INC., Hsinchu City (TW)

(72) Inventors: Chia-Hao YU, Hsinchu City (TW); Tzu-Han CHOU, San Jose, CA (US); Chin-Kuo JAO, Hsinchu City (TW); Jiann-Ching GUEY, Hsinchu City (TW)

(21) Appl. No.: 18/836,040

(22) PCT Filed: Mar. 20, 2023
(86) PCT No.: PCT/CN2023/082567

§ 371 Date: Aug. 6, 2024

Related U.S. Application Data
(60) Provisional application No. 63/321,795, filed on Mar. 21, 2022.

(51) Int. Cl. H04B 7/06; H04L 5/00

(52) U.S. Cl. CPC H04B 7/0626; H04B 7/0658; H04L 5/0051

(57) ABSTRACT

Various solutions for channel information feedback with respect to user equipment and network apparatus in mobile communications are described. An apparatus may receive a reference signal transmitted by a network side including one or more than one network nodes. The apparatus may derive a channel response information observed by a receiving domain of the apparatus according to the reference signal. The apparatus may decompose the channel response information into a two-dimensional domain to obtain a linear combination coefficient representation of the channel response information in the two-dimensional domain. The apparatus may report a compressed channel information to the network side based on the linear combination coefficient representation and the two-dimensional domain.

### CROSS REFERENCE TO RELATED PATENT APPLICATION(S)

The present disclosure claims the priority benefit of U.S. Provisional Patent Application No. 63/321,795, filed on 21 Mar. 2022. The content of aforementioned application is herein incorporated by reference in its entirety.

### TECHNICAL FIELD

The present disclosure is generally related to mobile communications and, more particularly, to channel information feedback with respect to user equipment (UE) and network apparatus in mobile communications.

### BACKGROUND

Unless otherwise indicated herein, approaches described in this section are not prior art to the claims listed below and are not admitted as prior art by inclusion in this section.

Channel State Information Reference Signal (CSI-RS) is a reference signal (RS) that is used in the downlink (DL) direction in 5G NR, for the purpose of channel sounding and used to measure the characteristics of a radio channel so that it can use correct modulation, code rate, precoder, beam forming etc. UEs will use these reference signals to measure the quality of the DL channel and report this in the uplink (UL) through the CSI reports. The network node sends CSI-RSs for measuring channel status information such as CSI-Reference Signal Receiving Power (RSRP), CSI-Reference Signal Receiving Quality (RSRQ) and CSI-Signal to Interference plus Noise Ratio (SINR) for mobility procedures. Specific instances of CSI-RSs can be configured for time/frequency tracking and mobility measurements. CSI feedback is the way of indicating certain reports by the UE to the network for indicating channel parameters for, e.g., dynamic scheduling purpose. CSI parameters are the quantities related to the state of a channel. The UE reports CSI parameters to the network node (e.g., gNB) as feedback. The CSI feedback includes several parameters, such as the Channel Quality Indicator (CQI), the Precoding Matrix Indicator (PMI) with different codebook sets and the Rank Indicator (RI). The CSI feedback may also include parameters for indicating a CSI-RS resource (or CSI-RS resource set) based on which the CQI, PMI and RI are derived and reported. The UE uses the CSI-RS to measure the CSI feedback. Upon receiving the CSI parameters, the network node can schedule downlink data transmissions (e.g., modulation scheme, code rate, number of transmission layers and MIMO precoding) accordingly.

In current NR CSI framework, the UE feeds back the UE preferred precoders for CSI feedback. Current CSI report considers a single transmission/reception point (TRP)-UE signal channel. Each UE reports a preferred precoder observed by the UE. The reported precoder may not reflect real channel status and does not consider the interference from transmissions for other UEs. This may be suitable for Single-User Multiple-Input Multiple-Output (SU-MIMO) scenarios where inter-user interference is not a major concern. However, this is not a preferred solution for Multiple-User Multiple-Input Multiple-Output (MU-MIMO) scenarios. The network node cannot determine proper precoders and thus is not able to manage the interferences among multiple UEs. Although the network node may perform some processes to make the signals more orthogonal among different UEs. But such processes may cause signal power loss and may degrade the signal performance.

Accordingly, how to feedback real/proper channel information for channel and interference management becomes an important issue in the newly developed wireless communication network. Therefore, there is a need to provide proper schemes to perform CSI measurement and reporting.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to channel information feedback with respect to user equipment and network apparatus in mobile communications.

In one aspect, a method may involve an apparatus receiving a reference signal transmitted by a network side including one or more than one network nodes. The method may also involve the apparatus deriving a channel response information observed by a receiving domain of the apparatus according to the reference signal. The method may further involve the apparatus decomposing the channel response information into a two-dimensional domain to obtain a linear combination coefficient representation of the channel response information in the two-dimensional domain. The method may further involve the apparatus reporting a compressed channel information to the network side based on the linear combination coefficient representation and the two-dimensional domain.

In one aspect, an apparatus may comprise a transceiver which, during operation, wirelessly communicates with at least one network node of a network side. The apparatus may also comprise a processor communicatively coupled to the transceiver. The processor, during operation, may perform operations comprising receiving, via the transceiver, a reference signal transmitted by the network side. The processor may also perform operations comprising deriving a channel response information observed by a receiving domain of the apparatus according to the reference signal. The processor may further perform operations comprising decomposing the channel response information into a two-dimensional domain to obtain a linear combination coefficient representation of the channel response information in the two-dimensional domain. The processor may further perform operations comprising reporting, via the transceiver, a compressed channel information to the network side based on the linear combination coefficient representation and the two-dimensional domain.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting example scenarios under schemes in accordance with implementations of the present disclosure.

FIG. 4 is a diagram depicting an example scenario under schemes in accordance with implementations of the present disclosure.

FIG. 5 is a block diagram of an example communication system in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to channel information feedback with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

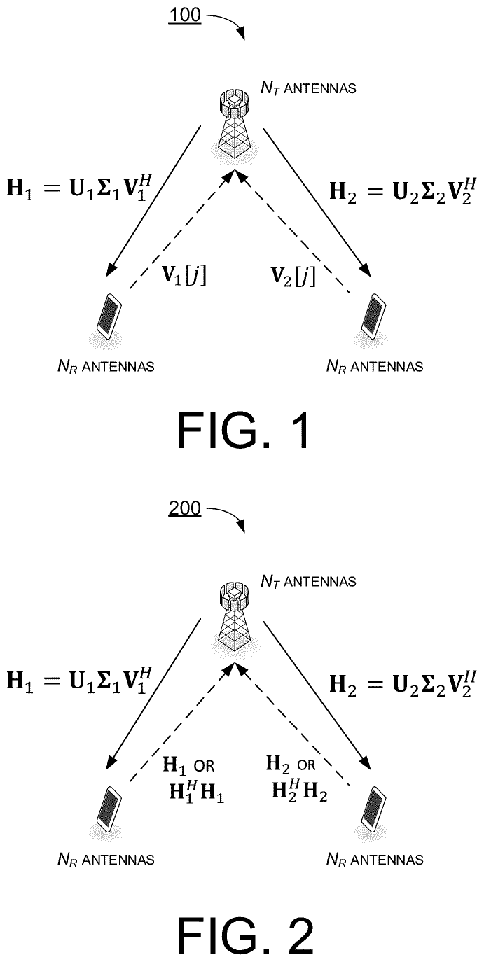

FIG. 1 illustrates an example scenario 100 under schemes in accordance with implementations of the present disclosure. Scenario 100 involves at least one network node and a plurality of UEs, which may be a part of a wireless communication network (e.g., an LTE network, a 5G/NR network, an IoT network or a 6G network). Scenario 100 illustrates the current NR CSI framework. A plurality of UEs (e.g., UE 1 and UE 2) may connect to the network side. The network side may comprise one or more than one network nodes. The network node may transmit the CSI-RS to the UE(s) via N_{T} antennas. Each UE may acquire the channel information between itself and the network node by measuring the CSI-RS via NR antennas and transmit corresponding CSI feedback to the network node. For elaboration purpose, it is assumed a narrowband system where the channel information between a NW node and a UE is described by a N_{R}×N_{T} matrix. It will be extended to a wideband system model in the later part of the present disclosure. Let H denote the channel information between the UE and the network node. H can be represented by singular value decomposition H=UΣV^{H}, where U denotes a left eigenvector matrix which may be utilized at receiver side for signal reception, Σ denotes a diagonal eigenvalue matrix (e.g., representing independent subchannel gains), and V denotes a right eigenvector matrix which may be utilized for precoding at transmitter side. H₁ represents the channel information between the UE 1 and the network node. H₂ represents the channel information between the UE 2 and the network node. In current NR CSI reporting scheme, the UE reports a preferred precoding matrix (e.g., V₁[j] or V₂[j]) to the network node based on a rank assumption where the rank assumption may be reported in a rank indication. However, the reported preferred precoding matrix may not represent the real/whole channel information (e.g., H₁ or H₂) between the network node and the UEs. Without the correct/comprehensive channel information, the network node is not able to well schedule the data transmissions and manage interferences among multiple UEs well.

FIG. 2 illustrates an example scenario 200 under schemes in accordance with implementations of the present disclosure. Scenario 200 involves at least one network node, and one or a plurality of UEs, which may be a part of a wireless communication network (e.g., an LTE network, a 5G/NR network, an IoT network or a 6G network). Scenario 200 illustrates a novel CSI reporting scheme according to proposed schemes of the present disclosure. Instead of reporting the preferred precoding matrix, the UE may be configured to report the whole channel information to the network side. The channel information may comprise H or H^{H}H, where the operator “^{H}” denotes Hermitian transpose, i.e., conjugate transpose of a matrix. The UE 1 may report the channel information (e.g., H₁ or H₁^{H}H₁) between the UE 1 and the network node. The UE 2 may report the channel information (e.g., H₂ or H₄^{H}H₂) between the UE 2 and the network node. In distributed MIMO scenarios, the network side antenna ports jointly serving a UE can be geographically separated. Compared with a traditional scenario where a specific UE is served by one network node, in distributed MIMO scenario the specific UE may be served by more than one network nodes. In a case that some network nodes are simultaneously serving a few UEs in same resources in distributed MIMO setup, inter-user interference appears. To manage such inter-user interference properly, the knowledge of the channel information between associated network nodes and associated UEs is very beneficial. Essentially, full channel information enables better joint precoder design so that the inter-user interference links are transformed into signal links. Though challenging, coherent Joint Transmission (CJT) scheme is a technique allowing to realize the benefit described above in the distributed MIMO scenario. Accordingly, with comprehensive channel information between network nodes and UEs, the network nodes may be able to well schedule data transmissions and manage interferences among UEs.

In order to enable interference management capability at the network side, the channel information fed back from the UE can be implemented by feeding back the information related to H or H^{H}H. For example, the UE may feedback right eigenvectors and eigenvalues based on Singular Value Decomposition (SVD) of H. Equivalently, the UE may also feedback the eigenvectors and eigenvalues based on Eigen Value Decomposition (EVD) of H^{H}H. The network node can derive the channel information based on the reported information related to H or H^{H}H. Consequently, the network node can acquire the channel information of all UEs. The network node may optimize the precoders (e.g., better orthogonality) to minimize the interferences for MU-MIMO scenarios accordingly.

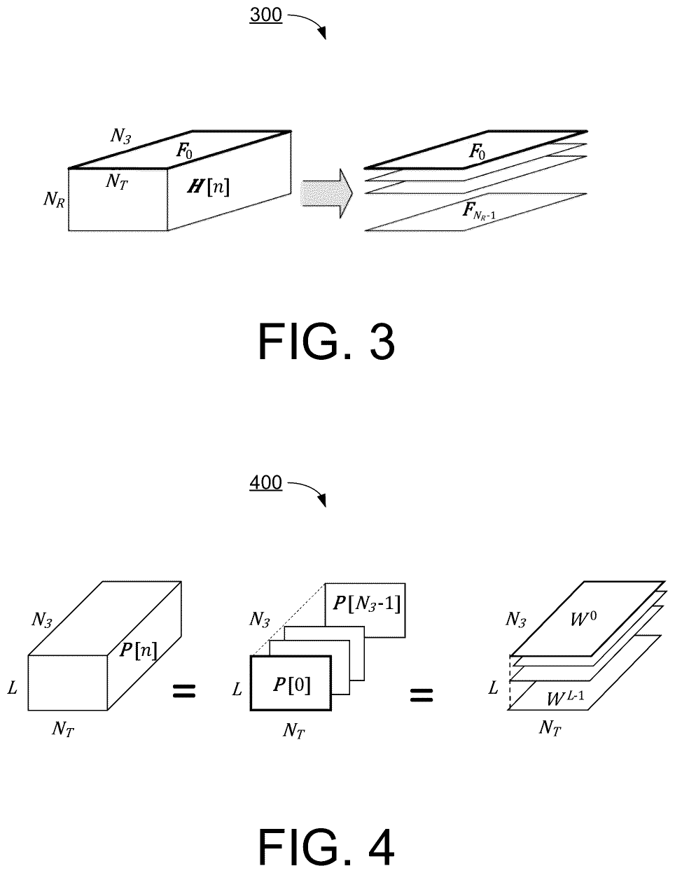

In the following descriptions, the narrowband representation above are extended into wideband representation. For this purpose, frequency domain consideration will be introduced to the channel information. FIG. 3 illustrates an example scenario 300 under schemes in accordance with implementations of the present disclosure. Scenario 300 involves at least one network node, and one or more UEs, which may be a part of a wireless communication network (e.g., an LTE network, a 5G/NR network, an IoT network or a 6G network). Scenario 300 illustrates an example of channel matrix decomposition method according to proposed schemes of the present disclosure. Both spatial domain (e.g., antenna ports) and frequency domain correlation can be exploited for CSI representation. Specifically, a 3-dimensional downlink (DL) channel information may be represented by N_{R}×N_{T}×N₃, where N_{R} denotes antenna ports number at the UE (e.g., 4 antenna ports), N_{T} denotes antenna ports number at the at least one network node (e.g., 32 antenna ports), and N₃ denotes number of frequency sub-bands to be reported. In each sub-band, its spatial channel response may be considered flat. In an extreme case, one sub-band may consist of 1 subcarrier. In general case, one sub-band may consist of more than 1 subcarriers. The 3-dimensional DL channel information can be represented by either {H[n]∈N_{R}×N_{T}, n=0, . . . , N₃−1} or {F_{T}∈N_{T}×N₃, r=0, . . . , N_{R}−1}. The network node may transmit the reference signal (e.g., CSI-RS) to the UE via N_{T} antennas. The UEs may receive the CSI-RS via N_{R} antennas. The UE may be configured to report CSI feedbacks in N₃ frequency sub-bands or sub-carriers. The UE may determine a N_{R}×N_{T} MIMO channel matrix by for each sub-band. Thus, the cuboid shown in FIG. 3 may represent the channel information observed by the UE. The UE may determine the channel information matrices by {H[n], n=0, . . . , N₃−1} (e.g., 12 H[n]: 32×4 matrices for representing the channels in 12 subbands).

The channel information matrices {H[n], n=0, . . . , N₃−1} may represent the full channel information between the UE and the network node. However, the signal overhead for reporting the entire matrices {H[n], n=0, . . . , N₃−1} is huge. Directly reporting {H[n], n=0, . . . , N₃−1} is a burden and inefficient for radio resources. Therefore, the UE may perform some compression processes to reshape/refine the channel information matrices and reduce the signal overhead. Specifically, the UE may derive a channel response information observed by a receiving domain of the UE according to the reference signal. The receiving domain may comprise the antenna ports of the UE. For example, the UE may decompose/reshape the channel information matrices {H[n], n=0, . . . , N₃−1} into a plurality of slices/channel response information (e.g., Fᵣ, r=0 . . . . N_{R}−1) observed by r^{th} receive antenna port of the UE as illustrated in FIG. 3. Each slice/channel response information may be represented by an N_{T}×N₃ matrix. The channel response information {Fᵣ, r=1 . . . . N_{R}−1} is equivalent to the channel information matrices {H[n], n=0, . . . , N₃−1} and represents the channel information observed by the receive antenna ports of the UE.

Then, the UE may decompose/project the channel information matrices {H[n], n=0, . . . , N₃−1} into a two-dimensional domain. The two-dimensional domain may comprise a first domain related to the network node spatial domain transformation (e.g., the antenna ports of the network node) and a second domain related to a frequency domain transformation. The transformation of the first domain and the second domain is based on Fourier transform. Specifically, the UE may determine a first bases (e.g., discrete Fourier transform (DFT) basis) for the spatial domain (e.g., TX beams of the network node). The UE may determine a second bases (e.g., DFT basis) for the frequency domain (e.g., delay taps). The UE may project the channel response information Fᵣ into the first bases and the second bases. For example, the channel response information F, may be represented by Fᵣ=

$${W}_{1} {Λ}^{r} {W}_{f}^{H} = [ \begin{matrix}{s}_{1} & … & {s}_{{N}_{T}}\end{matrix} ] [ \begin{matrix}{λ}_{1 , 1}^{r} & … & {λ}_{1 , {N}_{3}}^{r} \\ ⋮ & ⋱ & ⋮ \\ {λ}_{{N}_{T} , 1}^{r} & … & {λ}_{{N}_{T} , {N}_{3}}^{r}\end{matrix} ] [ \begin{matrix}{f}_{1}^{H} \\ ⋮ \\ {f}_{{N}_{3}}^{H}\end{matrix} ] .$$

W₁ denotes the spatial bases, where sᵢ is i^{th} spatial basis (e.g., i^{th} beam). W_{f} denotes the frequency domain bases, where fₘ is m^{th} frequency domain basis (e.g., m^{th} tap). The first bases and the second bases may be pre-stored/pre-defined in the UE and the network node(s). The UE may determine/select the first bases and the second bases according to some parameters (e.g., receive antenna ports).

After projecting the channel response information into the bases, the UE may obtain a linear combination coefficient representation (e.g., a matrix representing linear combination coefficients) Λ^{r} per receive antenna port of the UE. The channel response information Fᵣ may be represented by Fᵣ=W₁Λ^{r}W_{f}^{H} for r=0 . . . . N_{R}−1. Denoting elements of the linear combination coefficient representation by Λ^{r}=[λᵢₘ^{r}], i=0, . . . , N_{T}−1, m=0, . . . , N₃−1, each element λᵢₘ^{r} is associated with a spatial basis sᵢ and a frequency basis fₘ. To report Fᵣ to the network node, one example is to report entire Λ^{r}. With the knowledge of the used spatial and frequency bases used to acquire Λ^{r}, the network node can recover/reconstruct the original Fᵣ. If the reporting extends to all r=0 . . . . N_{R}−1, the entire channel information between the network node and the UE is known to the network node. If the spatial and frequency domain bases are properly selected, the linear combination coefficient representation Λ^{r} may be a sparse matrix. Furthermore, feedback compression may be achieved by reporting non-zero linear combination coefficients, λᵢₘ^{r}, and their associated spatial and frequency domain basis. In one example, some elements may be omitted from feedback if too weak compared to other ports, for example, in terms of magnitude. In this case, only strong element(s), λᵢₘ^{r}, and its associated spatial/frequency basis, sᵢ/fₘ, are fed back. To feedback the associated spatial/frequency basis sᵢ/fₘ, only the position indices i and m are required. The UE may omit at least one element of the linear combination coefficient representation in an event that the at least one element is less than a threshold or a pre-determined value. The UE may select at least one dominant component of the linear combination coefficient representation and report information related to the at least one dominant component to the network node. For example, in a case that there are 32 transmit antenna ports for the network node and after spatial and frequency domain projection, only 4 significant elements in Λ^{r} are determined. Then, Fᵣ can be compressed and represented by only 4 pairs of {λᵢₘ, i, m} There will be a compression gain by such projection. Thus, instead of reporting the channel information matrices {H[n], n=0, . . . , N₃−1}, reporting it based on the linear combination coefficient representation Λ^{r} will be more efficient. The network node is able to reconstruct the channel information H by the reported linear combination coefficient representation Λ^{r} for all r=0 . . . . N_{R}−1.

To further reduce the signaling overhead of the CSI feedbacks, some compression schemes for reporting the linear combination coefficient representation for r=0 . . . . N_{R}−1 may be applied. In a first compression scheme, the UE may obtain a plurality of linear combination coefficients matrices corresponding to a plurality of antenna ports of the apparatus. The UE may determine a differential part of at least one of the linear combination coefficient representation. The UE may report the differential part to the network node. At first, the UE may need to report a full linear combination coefficient representation. For example, the linear combination coefficient representation corresponding to the first receive antenna Λ¹, is fully reported or based on the technique discussed above. Then, the UE may only report the differential parts compared to the full linear combination coefficient representation of the first receive antenna. In another example, linear combination coefficient representation corresponding to a first reporting time are reported first. In a second reporting time later than the first reporting time, differential linear combination coefficients compared to the ones in the first reporting time are reported. The differential values may be obtained by comparing linear combination coefficients between same receive antenna port but different reporting time. In yet another example, a combination of the above two example may be used, where the linear combination coefficient representation of a specific receive antenna (e.g., the first one) and a reference reporting time is used as reference for calculating differential values. Thus, the UE does not need to report all information for each linear combination coefficient representation. The CSI feedback reporting signaling can be reduced.

In some implementations, the UE may only report the differential parts of the same λ_{i,m} elements in phase-only, magnitude-only or both phase and magnitude. For example, the linear combination coefficient representation Λ^{r} may be expressed by

$${Λ}^{r} = [ \begin{matrix}{λ}_{1 , 1}^{r} & … & {λ}_{1 , {N}_{3}}^{r} \\ ⋮ & ⋱ & ⋮ \\ {λ}_{{N}_{T} , 1}^{r} & … & {λ}_{{N}_{T} , {N}_{3}}^{r}\end{matrix} ] .$$

Each element λ_{i,m}^{r} may comprise 8 bits for expressing an absolute value. There are 0, . . . , N_{R}−1 full linear combination coefficient representations. However, there exist some correlations between these representations. The variances between these representations may not be significant. For the feedback of per receive antenna linear combination coefficient representation Λ^{r} for r=0, . . . , N_{R}−1, correlation between Λ^{r} for different r value (e.g., correspond to different receive antennas) may be used. For same elements in Λ^{r} between different r's (e.g., same {spatial domain, frequency domain} position), the UE may report the differential feedback in phase-only, magnitude-only or both phase and magnitude. For example, for a differential matrix Λ^{r}′ expressed by

$${Λ}^{r ′} = [ \begin{matrix}{λ}_{1 , 1}^{r ′} & … & {λ}_{1 , {N}_{3}}^{r ′} \\ ⋮ & ⋱ & ⋮ \\ {λ}_{{N}_{T} , 1}^{r ′} & … & {λ}_{{N}_{T} , {N}_{3}}^{r ′}\end{matrix} ] .$$

Each element λ_{i,m}^{r}′ may only comprise 3 bits for expressing a differential value. The UE may report Λ¹ in absolute values, and report Λ^{r} for r>1 in differential values with respect to Λ¹. The values here can be phase-only, magnitude-only or both phase and magnitude. In a case where both phase and magnitude are used for differential value, Λ^{r}′=Λ^{r}−Λ¹. Thus, the UE only need to report the differential matrix Λ^{r}′ with a reduced signaling overhead.

In a second compression scheme, the UE may obtain a plurality of linear combination coefficient representations corresponding to a plurality of antenna ports of the apparatus. The UE may select a plurality of elements from the linear combination coefficient representations. Each of the plurality of elements may correspond to a same entry of different linear combination coefficient representations. The UE may project the elements to a third-dimension domain to obtain a further linear combination coefficient representation. The UE may report the further linear combination coefficient representation to the network node. The third-dimension domain may comprise a receive (RX) spatial domain.

In some implementations, the UE may line up same (i,m) elements in all Λ^{r} as Γ_{i,m}=[λ_{i,m}⁰, λ_{i,m}¹, . . . , λ_{i,m}^{N}^{_{R}}⁻¹]. The UE may project it in a set of selected RX spatial-domain basis. The UE may feedback only the linear combination coefficients of the RX spatial-domain basis set. For example, for same elements (i,m) in Λ^{r} between different r's (e.g., same {spatial domain, frequency domain} position), Γ_{i,m}=[λ_{i,m}⁰, λ_{i,m}¹, . . . , λ_{i,m}^{N}^{_{R}}⁻¹] is further projected into a set of RX spatial-domain bases. Thus, Tim can be expressed as linear combination coefficients of the set of RX spatial-domain bases. For example, the projection may be expressed by

$${Γ}_{i , m} = [ {λ}_{i , m}^{0} , {λ}_{i , m}^{1} , … , {λ}_{i , m}^{{N}_{R} - 1} ] = [ \begin{matrix}{c}_{i , m}^{0} & … & {c}_{i , m}^{{N}_{R} - 1}\end{matrix} ] [ \begin{matrix}{a}_{1}^{H} \\ ⋮ \\ {a}_{{N}_{R}}^{H}\end{matrix} ] ,$$

where aᵣ^{H}, r=0, . . . , N_{R}−1 denotes the RX 1-by-N_{R} spatial-domain basis. [c_{i,m}⁰ . . . c_{i,m}^{N}^{_{R}}⁻¹] denotes the linear combination coefficients. The RX spatial-domain bases may be a DFT basis which may be pre-defined/pre-stored for both the UE and the network node. Once the RX spatial domain (e.g., receive antenna ports) is confirmed, the corresponding basis may be determined/selected. If a proper basis is used, the projected linear combination coefficients can become sparse. There will be a compression gain by the projection. The network node is able to reconstruct the channel matrix based on the reported basis and the reported linear combination coefficients. The base set used for compression may be pre-defined/pre-specified, or reported to the network node after selected by UE from, e.g., a (pre-) configured set.

In some implementations, only significant elements of the linear combination coefficient representation may be fed back. For example, significant elements may be determined by comparing magnitude. The ones with stronger/larger magnitude (e.g., greater than a threshold, or strongest N elements) are determined as significant ones. The number of feedback element can be one. The other elements with weaker/smaller magnitude (e.g., less than a threshold) may be omitted to reduce the signaling overhead.

FIG. 4 illustrates an example scenario 400 under schemes in accordance with implementations of the present disclosure. Scenario 400 involves at least one network node and one or more than one UEs, which may be a part of a wireless communication network (e.g., an LTE network, a 5G/NR network, an IoT network or a 6G network). Scenario 400 illustrates an example of feeding back the information related to the channel covariance matrix H^{H}H according to proposed schemes of the present disclosure. Similarly, both spatial domain (e.g., antenna ports) and frequency domain correlation can be exploited for CSI representation (e.g., H^{H}H). The network node may transmit the reference signal (e.g., CSI-RS) to the UE via N_{T} antennas. N_{T} denotes the number of transmit antenna ports of the network node(s) (e.g., 32 antenna ports). The UEs may receive the CSI-RS by N_{R} receive antenna ports of the UE (e.g., 4 antenna ports). The UE may be configured to report CSI feedbacks in N₃ frequency sub-bands or sub-carriers. N₃ denotes the number of sub-bands/sub-carriers that the UE needs to report (e.g., 12 sub-bands). The UE may determine a precoder matrix by N_{T}×L for each sub-band, where L≤N_{R} denotes the number of spatial layers constructed by the precoder matrix. The cuboid showed in FIG. 4 may represent the precoder information derived by the UE. The UE may determine the precoder matrix per-sub-band by {P[n]∈N_{T}×L, n=0, . . . , N₃−1} (e.g., each P[n] is represented by a 32×12 matrix).

A channel covariance matrix H[n] #H[n] may represent enough channel information between the UE and the network node(s) for precoder derivation in multi-user scenario. However, the signal overhead for reporting the entire H[n] “H[n] matrix is huge. Directly reporting the H[n]” H[n] matrix is a burden and inefficient for radio resources. Therefore, the UE may perform some compression processes to reshape/refine the channel covariance matrix and reduce the signal overhead. Specifically, the UE may receive a reference signal transmission from the network node(s). The UE may derive a channel information observed by a receiving domain of the UE according to the reference signal. The receiving domain may comprise the spatial layer of the UE. The channel information may comprise the precoder matrix. For example, the UE may decompose/reshape the per-sub-band precoders {P[n]: N_{T}×L, n=1, . . . , N₃} into a plurality of per-layer precoders {W^{r}: N_{T}×N₃, r=1, . . . , L} across sub-bands, where L≤N_{R} is the number of spatial layers. Each per-layer precoder may be represented by an N_{T}×N₃ matrix. The information {W^{r}, r=1, . . . , L} is equivalent to the information {P[n], n=1, . . . , N₃} and represents the precoder information (spatial layers) observed by the UE.

Then, the UE may decompose/project the per-layer precoder matrix W^{r} into a two-dimensional domain to obtain a linear combination coefficient representation (e.g., a matrix representing linear combination coefficients). The UE may report the channel information to the network node(s) based on the linear combination coefficients in the linear combination coefficient representation. The two-dimensional domain may comprise a first domain related to the network node(s) spatial domain transformation (e.g., the antenna ports of the network node(s)) and a second domain related to a frequency domain transformation. The transformation of the first domain and the second domain is based on Fourier transform. Specifically, the UE may determine a first basis (e.g., DFT basis) for the spatial domain (e.g., TX beams of the network node(s)). The UE may determine a second basis (e.g., DFT basis) for the frequency domain (e.g., delay taps). The UE may project the precoder matrix W^{r} into the first basis and the second basis. For example, the precoder matrix W^{r} may be represented by

$${W}^{r} = {W}_{1} {W}_{2}^{r} {W}_{f}^{H} = [ \begin{matrix}{s}_{1} & … & {s}_{{N}_{T}}\end{matrix} ] [ \begin{matrix}{c}_{1 , 1}^{r} & … & {c}_{{N}_{3} , 1}^{r} \\ ⋮ & ⋱ & ⋮ \\ {c}_{1 , {N}_{T}}^{r} & … & {c}_{{N}_{3} , {N}_{T}}^{r}\end{matrix} ] [ \begin{matrix}{f}_{1}^{H} \\ ⋮ \\ {f}_{{N}_{3}}^{H}\end{matrix} ] .$$

W₁ denotes the spatial bases, where sᵢ is i^{th} spatial basis (e.g., i^{th} beam). W_{f} denotes the frequency domain bases, where fₘ is m^{th} frequency domain basis (e.g., m^{th} tap). The first bases and the second bases may be pre-stored/pre-defined in the UE and the network node(s). The UE may determine/select the first bases and the second bases according to some parameters (e.g., receive antenna ports).

A channel information matrix can be decomposed into the product of three matrices by Singular Value Decomposition (SVD). With SVD, a spatial channel matrix H: N_{R}×N_{T} may be expressed by H=UΣV^{H}. Inserting sub-band index n in this case, it results in H[n]=U[n]Σ[n]V^{H}[n]. Then, the channel covariance matrix H^{H}[n]H[n] may be expressed by H^{H}[n]H[n]=V[n]Σ²[n]V^{H}[n], where Σ²[n]=Σ^{H}[n]Σ[n]: N_{T}×N_{T}. For reconstructing H^{H}[n] H[n], some information reporting schemes may be used. For example, the UE may report the V matrix and the Σ matrix to the network node(s). The network node(s) can reconstruct the channel information based on the reported V matrix and Σ matrix.

In some implementations, the UE may report a matrix P[n]=V[n] for all n. The matrix P[n] can be fed back based on the similar approach as the precoder matrix W^{r} by feeding back the reshaped per-layer precoder. In one example, eigenvectors in V[n] corresponding to zero eigenvalues in Σ[n] are omitted from feedback. Only eigenvectors corresponding to non-zero coefficients in Σ[n] or Σ²[n], denoted by V′[n], are fed back. In addition, the UE may report the non-zero coefficients in diagonal terms from Σ[n] or Σ²[n] for all n.

In some implementations, the UE may obtain a plurality of linear combination coefficient representations corresponding to a plurality of precoder matrices. The UE may report the precoders to the network node(s). There may be no or weak correlation between different precoders. Specifically, the UE may report a matrix P[n]=Σ²[n] V[n]. The reshaped per-layer precoder matrices W^{r}'s according to P[n]'s are decomposed into spatial-domain and frequency-domain bases and can be expressed by a linear combination coefficient representation W₂^{r}, r=0, . . . , L−1, where W^{r}=W₁W₂^{r}W_{f}^{H}. In another example, the UE may report a matrix P[n]=Σ[n]V[n]. It is possible to normalize the element(s) with the largest magnitude to e.g., 1, for individual W^{r}, and additionally feeds back a wideband term representing the value of the largest magnitude for each W^{r}. Similarly, some elements may be omitted from feedback if too weak compared to other ports, for example, in terms of magnitude.

In some implementations, the UE may obtain a plurality of linear combination coefficient representations corresponding to a plurality of precoders. The UE may report the precoders to the network node(s). The UE may report an ordering information corresponding to the precoders to the network node(s). Specifically, the UE may report P[n]=V[n] for all n and the information for ordering the vectors in P[n] to the network node(s). The UE may separately report Σ[n]. Ordering of per-layer precoder in P[n] (e.g., row vectors) needs to match its eigenvalues in Σ[n]. In one example, the ordering is based on the magnitude of diagonal element in Σ²[n] corresponding to individual precoders (e.g., row vectors) in P[n]=V[n]. In another example, the row vectors in V[n] are reported based on the magnitude ordering of diagonal elements in Σ²[n]. The ordering information may be implicitly carried by the reporting index/position of the row vectors in V[n]. In another example, P[n]=V[n] may be compressed based on the reporting scheme for the precoder matrix W^{r} mentioned above. Additional ordering information on individual per-layer precoder W can be reported. The ordering information may be carried by the order where per-layer precoder is reported. Similarly, some elements may be omitted from feedback if too weak compared to other ports, for example, in terms of magnitude.

It should be noted that, in some situations, reporting spatial covariance matrix H^{H}H may not be equivalent to reporting spatial matrix H. Since H=UΣV^{H}, the information on U matrix may be missed for if reporting H^{H}H and reconstructing the spatial matrix H may not be possible. However, for some precoders, no U matrix is needed. Reporting information related to V matrix and Σ matrix (e.g., reporting H^{H}H) is sufficient for reconstructing enough channel information.

In view of the above, the information about E matrix is reported. In addition, the UE considers/reports the observed channel information for each spatial layer rather than just reporting a preferred precoder. Accordingly, the network node(s) is able to reconstruct the comprehensive channel information based on the reported information and enable interference management capability at the network side.

In some implementations, the feedback information from the UE can be further compressed by feeding back only selective dominant components. For example, compression of each linear combination matrix Λ^{r} in Fᵣ=W₁Λ^{r}W_{f}^{H} for H[n] reconstruction may be applied. In addition, the correlation between Λ^{r} (for different r) can be utilized for further compression. In another example, compression of each linear combination matrix W₂^{r} in W^{r}=W₁W₂^{r}W_{f}^{H} for H^{H}[n]H[n] reconstruction may be applied. The compression may be achieved by providing information on coefficients (e.g., phase-only, magnitude-only, or both phase and magnitude) of dominant components. The reporting may be in differential forms. Alternatively, the compression may also be achieved by providing information on position of dominant components in linear combination matrices. A position for a dominant component may indicate corresponding spatial-domain basis and frequency-domain basis pair. Such compression based on selecting dominant components may be applied to any embodiments/examples in the present disclosure.

### Illustrative Implementations

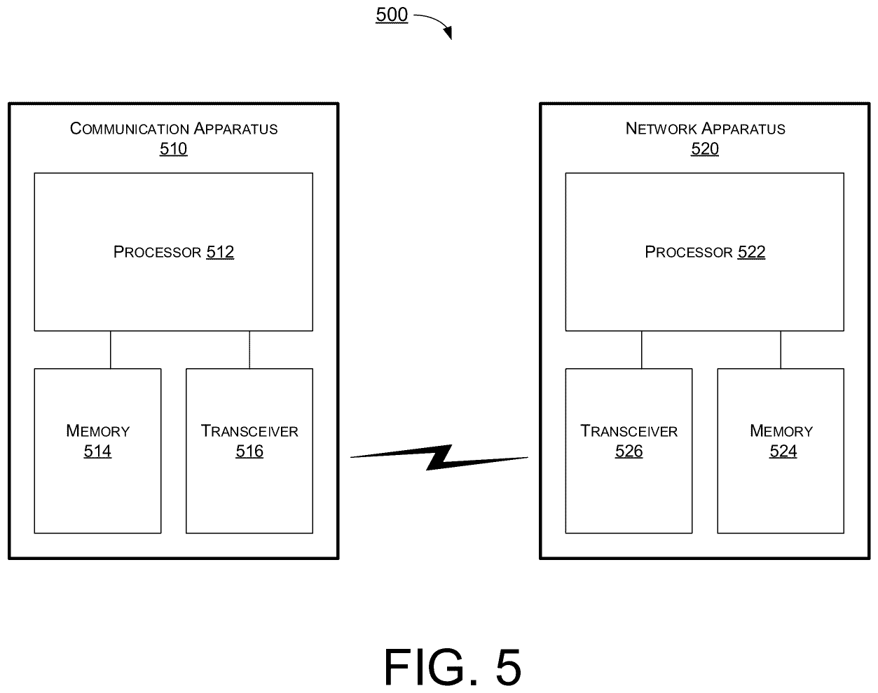

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to channel information feedback with respect to user equipment and network apparatus in mobile communications, including scenarios/schemes described above as well as process 600 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 910 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of a network apparatus, which may be a network node such as a satellite, a base station, a small cell, a router or a gateway. For instance, network apparatus 520 may be implemented in an eNodeB in an LTE network, in a gNB in a 5G/N_{R}, IoT, NB-IoT or IIoT network or in a satellite or base station in a 6G network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including autonomous reliability enhancements in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, communication apparatus 510 may further include a memory 514 coupled to processor 512 and capable of being accessed by processor 512 and storing data therein. In some implementations, network apparatus 520 may also include a transceiver 526 coupled to processor 522 and capable of wirelessly transmitting and receiving data. In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively. To aid better understanding, the following description of the operations, functionalities and capabilities of each of communication apparatus 510 and network apparatus 520 is provided in the context of a mobile communication environment in which communication apparatus 510 is implemented in or as a communication apparatus or a UE and network apparatus 520 is implemented in or as a network node of a communication network.

In some implementations, processor 512 may receiving, via transceiver 516, a reference signal from network apparatus 520. Processor 512 may derive a channel response information observed by a receiving domain of the apparatus according to the reference signal. Processor 512 may decompose the channel response information into a two-dimensional domain to obtain a linear combination coefficient representation of the channel response information in the two-dimensional domain. Processor 512 may report, via transceiver 516, a compressed channel information to network apparatus 520 based on the linear combination coefficient representation and the two-dimensional domain.

In some implementations, the receiving domain may comprise an antenna port of communication apparatus 510. The two-dimensional domain may comprise a first domain related to the network side spatial domain transformation and a second domain related to a frequency domain transformation. The transformation of the first domain and the second domain is based on Fourier transform. Processor 512 may report the compressed channel information corresponding to all receiving domains of communication apparatus 510.

In some implementations, the channel response information may comprise an N_{T}×N₃ matrix. N_{T} comprises a number of transmit antenna ports of the network side. N₃ comprises a number of sub-bands.

In some implementations, processor 512 may omit at least one element of the linear combination coefficient representation in an event that the at least one element is less than a threshold.

In some implementations, processor 512 may obtain a plurality of linear combination coefficient representations corresponding to a plurality of antenna ports of transceiver 516. Processor 512 may determine a differential part of at least one of the linear combination coefficient representations. Processor 512 may report, via transceiver 516, the differential part to network apparatus 520.

In some implementations, processor 512 may obtain a plurality of linear combination coefficient representations corresponding to a plurality of antenna ports of transceiver 516. Processor 512 may select a plurality of elements from the linear combination coefficients. Each of the plurality of elements may correspond to a same entry of different linear combination coefficient representations. Processor 512 may project the elements to a third-dimension domain to obtain a further linear combination coefficient representation. Processor 512 may report, via transceiver 516, the further linear combination coefficient representation to network apparatus 520.

In some implementations, the receiving domain may comprise a spatial layer. The channel response information may comprise a precoder.

In some implementations, processor 512 may obtain a plurality of linear combination coefficient representations corresponding to a plurality of precoders. Processor 512 may report, via transceiver 516, the precoders to network apparatus 520.

In some implementations, processor 512 may obtain a plurality of linear combination coefficient representations corresponding to a plurality of precoders. Processor 512 may report, via transceiver 516, the precoders to network apparatus 520. Processor 512 may report, via transceiver 516, an ordering information corresponding to the precoders to network apparatus 520.

In some implementations, processor 512 may select at least one dominant component of the linear combination coefficient representation. Processor 512 may report, via transceiver 516, information related to the at least one dominant component to network apparatus 520.

### Illustrative Processes

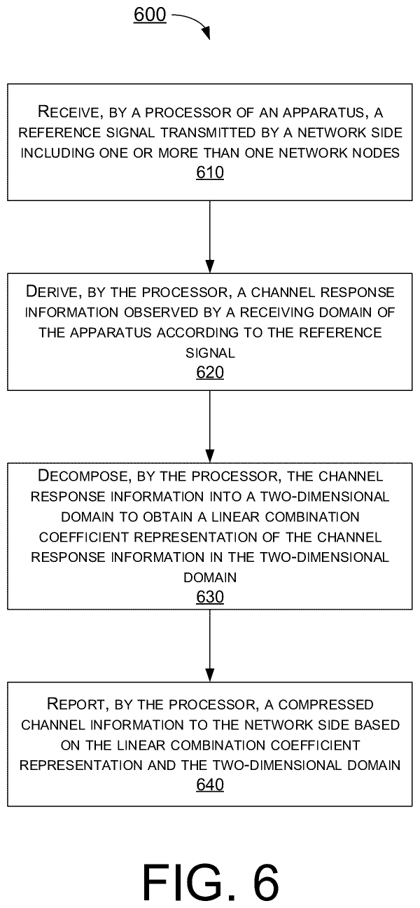

FIG. 6 illustrates an example process 600 in accordance with an implementation of the present disclosure. Process 600 may be an example implementation of above scenarios/schemes, whether partially or completely, with respect to channel information feedback with the present disclosure. Process 600 may represent an aspect of implementation of features of communication apparatus 510. Process 600 may include one or more operations, actions, or functions as illustrated by one or more of blocks 610, 620, 630 and 640. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510. Process 600 may begin at block 610.

At 610, process 600 may involve processor 512 of communication apparatus 510 receiving a reference signal transmitted by a network side including one or more than one network nodes. Process 600 may proceed from 610 to 620.

At 620, process 600 may involve processor 512 deriving a channel response information observed by a receiving domain of the apparatus according to the reference signal. The receiving domain may comprise an antenna port or a spatial layer. The channel matrix may comprise a precoder. Process 600 may proceed from 620 to 630.

At 630, process 600 may involve processor 512 decomposing the channel response information into a two-dimensional domain to obtain a linear combination coefficient representation of the channel response information in the two-dimensional domain. The two-dimensional domain may comprise a first domain related to the network node spatial domain transformation and a second domain related to a frequency domain transformation. Process 600 may proceed from 630 to 640.

At 640, process 600 may involve processor 512 reporting a compressed channel information to the network side based on the linear combination coefficient representation and the two-dimensional domain.

In some implementations, process 600 may further involve processor 512 omitting at least one element of the linear combination coefficient representation in an event that the at least one element is less than a threshold.

In some implementations, process 600 may further involve processor 512 obtaining a plurality of linear combination coefficient representations corresponding to a plurality of antenna ports of the apparatus. Process 600 may further involve processor 512 determining a differential part of at least one of the linear combination coefficient representations. Process 600 may further involve processor 512 reporting the differential part to the network node.

In some implementations, process 600 may further involve processor 512 obtaining a plurality of linear combination coefficient representations corresponding to a plurality of antenna ports of the apparatus. Process 600 may further involve processor 512 selecting a plurality of elements from the linear combination coefficient representations. Each of the plurality of elements may correspond to a same entry of different linear combination coefficient representations. Process 600 may further involve processor 512 projecting the elements to a third-dimension domain to obtain a further linear combination coefficient representation. Process 600 may further involve processor 512 reporting the further linear combination coefficient representation to the network side.

In some implementations, process 600 may further involve processor 512 obtaining a plurality of linear combination coefficient representations corresponding to a plurality of precoders. Process 600 may further involve processor 512 reporting the precoders to the network side.

In some implementations, process 600 may further involve processor 512 obtaining a plurality of linear combination coefficient representations corresponding to a plurality of precoders. Process 600 may further involve processor 512 reporting the precoders to the network side. Process 600 may further involve processor 512 reporting an ordering information corresponding to the precoders to the network side.

In some implementations, process 600 may further involve processor 512 selecting at least one dominant component of the linear combination coefficient representation. Process 600 may further involve processor 512 reporting information related to the at least one dominant component to the network side.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
receiving, by a processor of an apparatus, a reference signal transmitted by a network side including one or more than one network nodes;
deriving, by the processor, a channel response information observed by a receiving domain of the apparatus according to the reference signal;
decomposing, by the processor, the channel response information into a two-dimensional domain to obtain a linear combination coefficient representation of the channel response information in the two-dimensional domain; and
reporting, by the processor, a compressed channel information to the network side based on the linear combination coefficient representation and the two-dimensional domain.

2. The method of claim 1, wherein the two-dimensional domain comprises a first domain related to a network side spatial domain transformation and a second domain related to a frequency domain transformation.

3. The method of claim 2, wherein the transformation of the first domain and the second domain is based on Fourier transform.

4. The method of claim 1, further comprising:
omitting, by the processor, at least one element of the linear combination coefficient representation in an event that the at least one element is less than a threshold.

5. The method of claim 1, further comprising:
obtaining, by the processor, a plurality of linear combination coefficient representations corresponding to a plurality of antenna ports of the apparatus;
determining, by the processor, a differential part of at least one of the linear combination coefficient representations; and
reporting, by the processor, the differential part to the network side.

6. The method of claim 1, further comprising:
obtaining, by the processor, a plurality of linear combination coefficient representations corresponding to a plurality of antenna ports of the apparatus;
selecting, by the processor, a plurality of elements from the linear combination coefficient representations, wherein each of the plurality of elements corresponds to a same entry of different linear combination coefficient representations;
projecting, by the processor, the elements to a third-dimension domain to obtain a further linear combination coefficient representation; and
reporting, by the processor, the further linear combination coefficient representation to the network side.

7. The method of claim 1, wherein the receiving domain comprises a spatial layer, and wherein the channel response information comprises a precoder.

8. The method of claim 7, further comprising:
obtaining, by the processor, a plurality of linear combination coefficient representations corresponding to a plurality of precoders; and
reporting, by the processor, the precoders to the network side.

9. (canceled)

10. The method of claim 1, further comprising:
selecting, by the processor, at least one dominant component of the linear combination coefficient representation; and
reporting, by the processor, information related to the at least one dominant component to the network side.

11. The method of claim 1, wherein the receiving domain comprises an antenna port, and wherein the reporting comprises reporting the compressed channel information corresponding to all receiving domains of the apparatus.

12. An apparatus, comprising:
a transceiver which, during operation, wirelessly communicates with at least one network node of a network side; and
a processor communicatively coupled to the transceiver such that, during operation, the processor performs operations comprising:
receiving, via the transceiver, a reference signal transmitted by the network side;
deriving a channel response information observed by a receiving domain of the apparatus according to the reference signal;
decomposing the channel response information into a two-dimensional domain to obtain a linear combination coefficient representation of the channel response information in the two-dimensional domain; and
reporting, via the transceiver, a compressed channel information to the network side based on the linear combination coefficient representation and the two-dimensional domain.

13. The apparatus of claim 12, wherein the two-dimensional domain comprises a first domain related to a network side spatial domain transformation and a second domain related to a frequency domain transformation.

14. The apparatus of claim 13, wherein the transformation of the first domain and the second domain is based on Fourier transform.

15. The apparatus of claim 12, wherein, during operation, the processor further performs operations comprising:
omitting at least one element of the linear combination coefficient representation in an event that the at least one element is less than a threshold.

16. The apparatus of claim 12, wherein, during operation, the processor further performs operations comprising:
obtaining a plurality of linear combination coefficient representations corresponding to a plurality of antenna ports of the apparatus;
determining a differential part of at least one of the linear combination coefficient representations; and
reporting, via the transceiver, the differential part to the network side.

17. The apparatus of claim 12, wherein, during operation, the processor further performs operations comprising:
obtaining a plurality of linear combination coefficient representations corresponding to a plurality of antenna ports of the apparatus;
selecting a plurality of elements from the linear combination coefficient representations, wherein each of the plurality of elements corresponds to a same entry of different linear combination coefficient representations;
projecting the elements to a third-dimension domain to obtain a further linear combination coefficient representation; and
reporting, via the transceiver, the further linear combination coefficient representation to the network side.

18. The apparatus of claim 12, wherein the receiving domain comprises a spatial layer, and wherein the channel response information comprises a precoder.

19. The apparatus of claim 18, wherein, during operation, the processor further performs operations comprising:
obtaining a plurality of linear combination coefficient representations corresponding to a plurality of precoders;
reporting, via the transceiver, the precoders to the network side.

20. (canceled)

21. The apparatus of claim 12, wherein, during operation, the processor further performs operations comprising:
selecting at least one dominant component of the linear combination coefficient representation; and
reporting, via the transceiver, information related to the at least one dominant component to the network side.

22. The apparatus of claim 12, wherein the receiving domain comprises an antenna port, and wherein, in reporting the compressed channel information, the processor reports the compressed channel information corresponding to all receiving domains of the apparatus.
